(19) United States
(12) Patent Application Publication
(10) Pub. No.: US 2022/0094491 A1
(43) Pub. Date: Mar. 24, 2022

(54) METHOD OF RECEIVING CHANNEL STATE INFORMATION FOR TERAHERTZ COMMUNICATION SYSTEM BASED-COMP OPERATION

(71) Applicant: LG ELECTRONICS INC., Seoul (KR)

(72) Inventors: Kukheon CHOI, Seoul (US); Jiwon KANG, (US); Kijun KIM, (US); Bonghoe KIM, (US)

(73) Assignee: LG ELECTRONICS INC., Seoul (KR)

(21) Appl. No.: 17/310,408

(22) PCT Filed: Jan. 31, 2019
(86) PCT No.: PCT/KR2019/001351

§ 371 Date: Jul. 30, 2021

(51) Int. Cl. H04L 5/00

(52) U.S. Cl. CPC H04L 5/0035; H04L 5/0057; H04L 5/0026

(57) ABSTRACT

A method of receiving, by a base station, channel state information (CSI) for a THz communication system based-CoMP operation may comprise the steps of: on the basis of beam information of each TRP, each panel, each BWP, or each cell, transmitting CSI association information of each TRP, each panel, each BWP, or each cell to a terminal; transmitting a first CSI request to the terminal; receiving first CSI from the terminal through a corresponding CSI feedback area according to a first reporting setting connected to the first CSI request; and on the basis of the first reporting setting, acquiring information on a TRP, a panel, a BWP, or a cell corresponding to the first CSI among each TRP, each panel, each BWP, or each cell.

### TECHNICAL FIELD

The present disclosure relates to wireless communication, and more particularly to a method for receiving channel state information (CSI) for a CoMP (Coordinated Multi-Point transmission/reception) operation based on a terahertz (THz) communication system.

### BACKGROUND ART

As more and more communication devices demand larger communication capacities according to introduction of a new radio access technology (NewRAT) system, the need for enhanced mobile broadband (eMBB) communication relative to the legacy radio access technologies (RATs) has emerged.

Massive machine type communication (mMTC) that provides various services by interconnecting multiple devices and things irrespective of time and place is also one of main issues to be addressed for future-generation communications. A communication system design considering services/user equipments (UEs) sensitive to reliability and latency is under discussion as well. As such, the introduction of a new RAT considering enhanced mobile broadband (eMBB), mMTC, ultra-reliability and low latency communication (URLLC), and so on is being discussed.

### DISCLOSURE

### Technical Problem

An object of the present disclosure is to provide a method for enabling a base station (BS) to receive channel state information (CSI) for a CoMP (Coordinated Multi-Point transmission/reception) operation based on a terahertz (THz) communication system.

Another object of the present disclosure is to provide a method for enabling a user equipment (UE) to transmit channel state information (CSI) for CoMP operation based on a terahertz (THz) communication system.

Another object of the present disclosure is to provide a base station (BS) for receiving channel state information (CSI) for CoMP operation based on a terahertz (THz) communication system.

Another object of the present disclosure is to provide a user equipment (UE) for transmitting channel state information (CSI) for CoMP operation based on a terahertz (THz) communication system.

The technical objects that can be achieved through the present disclosure are not limited to what has been particularly described hereinabove and other technical objects not described herein will be more clearly understood by persons skilled in the art from the following detailed description.

### Technical Solutions

In accordance with an aspect of the present disclosure, a method for enabling a base station (BS) to receive channel state information (CSI) for a CoMP (Coordinated Multi-Point transmission/reception) operation based on a terahertz (THz) communication system may include transmitting, to a user equipment (UE), CSI association information for each TRP (Transmission and Reception Point), each panel, each BWP (bandwidth part), or each cell based on beam information of each TRP, each panel, each BWP, or each cell, transmitting a first channel state information (CSI) request to the user equipment (UE), receiving first channel state information (CSI) from the user equipment (UE) through a corresponding CSI feedback region based on a first report setting connected to the first CSI request, and acquiring information of a TRP, a panel, a BWP, or a cell corresponding to the first CSI from among the TRP, the panel, the BWP, or the cell based on the first report setting.

The method may further include acquiring a precoding matrix indicator (PMI) subset of the TRP, the panel, the BWP, or the cell corresponding to the first CSI based on the CSI association information. The method may further include transmitting a second CSI request including the PMI subset to the user equipment (UE). The method may further include receiving a second CSI from the user equipment (UE) based on the second CSI request.

The beam information may include a precoding matrix indicator (PMI) acting as beam directivity information. The CSI association information may refer to information related to a single resource of each TRP, each panel, each BWP, or each cell.

The second CSI may include not only a best precoding matrix indicator (PMI), but also a channel quality indicator (CQI), L1-RSRP (Layer 1 reference signal received power), or L1-SINR (Layer 1-Signal to interference plus noise ratio) corresponding to the best PMI.

In accordance with another aspect of the present disclosure, a method for enabling a user equipment (UE) to transmit channel state information (CSI) for a CoMP (Coordinated Multi-Point transmission/reception) operation based on a terahertz (THz) communication system may include receiving CSI association information for each TRP (Transmission and Reception Point), each panel, each BWP (bandwidth part), or each cell based on beam information of each TRP, each panel, each BWP, or each cell, from a base station (BS), receiving a first channel state information (CSI) request from the base station (BS), and transmitting first channel state information (CSI) to the base station (BS) through a corresponding CSI feedback region based on a first report setting connected to the first CSI request.

The method may further include receiving a second CSI request based on the CSI association information from the base station (BS), wherein the second CSI request includes a precoding matrix indicator (PMI) subset of a TRP, a panel, a BWP, or a cell corresponding to the first CSI. The method may further include transmitting a second CSI to the base station (BS) based on the second CSI request, wherein the second CSI includes not only a best PMI, but also a channel quality indicator (CQI), L1-RSRP (Layer 1 reference signal received power), or L1-SINR (Layer 1-Signal to interference plus noise ratio) corresponding to the best PMI.

In accordance with another aspect of the present disclosure, a base station (BS) for receiving channel state information (CSI) for a CoMP (Coordinated Multi-Point transmission/reception) operation based on a terahertz (THz) communication system may include a transmitter configured to transmit, to a user equipment (UE), CSI association information for each TRP (Transmission and Reception Point), each panel, each BWP (bandwidth part), or each cell based on beam information of each TRP, each panel, each BWP, or each cell, and to transmit a first CSI request to the user equipment (UE), a receiver configured to receive first channel state information (CSI) from the user equipment (UE) through a corresponding CSI feedback region based on a first report setting connected to the first CSI request, and a processor configured to acquire information of a TRP, a panel, a BWP, or a cell corresponding to the first CSI from among the TRP, the panel, the BWP, or the cell based on the first report setting.

In accordance with another aspect of the present disclosure, a user equipment (UE) for transmitting channel state information (CSI) for a CoMP (Coordinated Multi-Point transmission/reception) operation based on a terahertz (THz) communication system may include a receiver configured to receive CSI association information for each TRP (Transmission and Reception Point), each panel, each BWP (bandwidth part), or each cell based on beam information of each TRP, each panel, each BWP, or each cell, from a base station (BS), and to receive a first channel state information (CSI) request from the base station (BS), and a transmitter configured to transmit first channel state information (CSI) to the base station (BS) through a corresponding CSI feedback region based on a first report setting connected to the first CSI request.

### Advantageous Effects

As is apparent from the above description, the embodiments of the present disclosure can reduce CSI feedback required for CoMP operation according to unique THz channel (e.g. 0.1-1 THz) characteristics.

It will be appreciated by persons skilled in the art that the effects that can be achieved with the present disclosure are not limited to what has been particularly described hereinabove and other advantages of the present disclosure will be more clearly understood from the following detailed description taken in conjunction with the accompanying drawings.

### DESCRIPTION OF DRAWINGS

The accompanying drawings, which are included as a part of the detailed description to help the understanding of the present disclosure, provide embodiments of the present disclosure, and together with the detailed description, explain the technical principle of the present disclosure.

FIG. 1 is a block diagram illustrating a wireless communication system according to the present disclosure.

FIG. 2 is a schematic diagram illustrating a hyper-hemispherical lens and directivity of the hyper hemispherical lens.

In FIG. 3, (a) is a schematic diagram illustrating an example of a THz lens, (b) is a schematic diagram illustrating an example of a THz dielectric mirror, and (c) is a schematic diagram illustrating an example of a THz antenna portion (or a THz antenna unit).

FIG. 4 is a conceptual diagram illustrating beam steering depending on the size and movement of lenses.

FIG. 5 is a conceptual diagram illustrating integration compatibility of the presented (or proposed) beam-steering metasurface.

FIG. 6 is a conceptual diagram illustrating beam steering with an integrated lens antenna.

FIG. 7 is a conceptual diagram illustrating a 77 GHz extended hemispherical lens antenna including a WR-10 open waveguide feed.

FIG. 8 is conceptual diagram illustrating an example of THz generation by photonic pulses.

FIG. 9 is a conceptual diagram illustrating 1THz outdoor-based available bands.

FIG. 10 is a conceptual diagram illustrating THz channel measurement (270-320 GHz).

FIGS. 11 to 14 illustrate channel impulse response (CIR) values measured in a direct transmission scenario for implementation of all four scenarios.

FIGS. 15 to 18 illustrate CIR values measured in direct NLOS (Non Line Of Sight) transmission scenario for implementation of all four scenarios.

FIG. 19 is a conceptual diagram illustrating THz TRP arrangement and CoMP when viewed from indoors.

FIG. 20 is a flowchart illustrating the order of utilizing one-to-one connection between channel state information (CSI) and a single resource of a TRP, a panel, a component carrier (CC), a bandwidth part (BWP), or a cell.

FIG. 21 is a flowchart illustrating the order of utilizing one-to-multiple connection between CSI and a single resource of a TRP, a panel, a CC, a BWP, or a cell.

### BEST MODE

Reference will now be made in detail to the preferred embodiments of the present disclosure, examples of which are illustrated in the accompanying drawings. The following detailed description includes details to provide full understanding of the present disclosure. Yet, it is apparent to those skilled in the art that the present disclosure can be implemented without these details. For instance, although the following descriptions are given in detail on the assumption that a mobile communication system includes 3GPP LTE, 3GPP LTE-A, and 5G systems, the following descriptions are applicable to other random mobile communication systems in a manner of excluding unique features of 3GPP LTE and 3GPP LTE-A.

Occasionally, to prevent the present disclosure from being vague, structures and/or devices known to the public are skipped or can be represented as block diagrams centering on the core functions of the structures and/or devices. Wherever possible, the same reference numbers will be used throughout the drawings to refer to the same or like parts.

In addition, in the following description, it is assumed that a terminal refers to a mobile or fixed user end device such as a user equipment (UE), a mobile station (MS), or an advanced mobile station (AMS). In addition, it is assumed that the base station collectively refers to any node of the network end communicating with the terminal, such as Node B, eNode B, Base Station, AP (Access Point), gNode B, and the like.

In a mobile communication system, a terminal or user equipment may receive information from a base station through a downlink, and the terminal may also transmit information through an uplink. Information transmitted or received by the terminal includes data and various control information, and various physical channels exist depending on the type and usage of information transmitted or received by the terminal.

The technology described herein is applicable to various wireless access systems such as code division multiple access (CDMA), frequency division multiple access (FDMA), time division multiple access (TDMA), orthogonal frequency division multiple access (OFDMA), single carrier frequency division multiple access (SC-FDMA), etc. The CDMA may be implemented as radio technology such as universal terrestrial radio access (UTRA) or CDMA2000. The TDMA may be implemented as radio technology such as global system for mobile communications (GSM), general packet radio service (GPRS), or enhanced data rates for GSM evolution (EDGE). The OFDMA may be implemented as radio technology such as the Institute of Electrical and Electronics Engineers (IEEE) 802.11 (Wi-Fi), IEEE 802.16 (WiMAX), IEEE 802-20, evolved UTRA (E-UTRA), etc. The UTRA is a part of a universal mobile telecommunication system (UMTS). 3rd generation partnership project (3GPP) long term evolution (LTE) is a part of evolved UMTS (E-UMTS) using E-UTRA and employs OFDMA in downlink and SC-FDMA in uplink. LTE-A (Advanced) is an evolved version of 3GPP LTE.

In addition, specific terms used in the following description are provided to help the understanding of the present disclosure, and the use of these specific terms may be changed to other forms without departing from the technical spirit of the present disclosure.

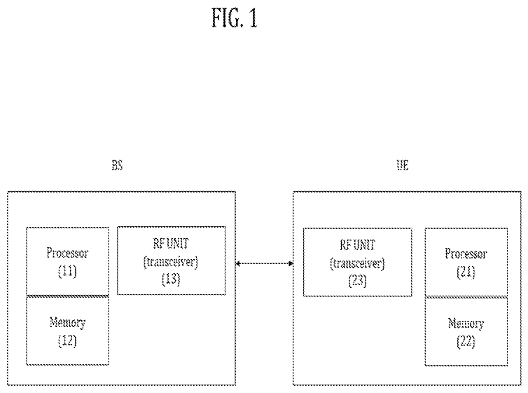

FIG. 1 is a block diagram illustrating a wireless communication system according to the present disclosure.

Referring to FIG. 1, the wireless communication system may include a base station (BS) 10 and at least one UE 20. On downlink, a transmitter may be a part of the BS 10, and a receiver may be a part of the UE 20. On uplink, the BS 10 may include a processor 11, a memory 12, and a radio frequency (RF) unit (also called a transceiver including the transmitter and the receiver) 13. The processor 11 may be constructed to implement the procedures and/or methods disclosed in the embodiments of the present disclosure. The memory 12 may be connected to the processor 11, and may store various information related to operations of the processor 11. The RF unit 13 is connected to the processor 11, and transmits and/or receives RF signals. The UE 20 includes a processor 21, a memory 22, and an RF unit 23 (also called a transceiver). The processor 21 may be constructed to implement the procedures and/or methods disclosed in the embodiments of the present disclosure. The memory 22 may be connected to the processor 21, and store various information related to operations of the processor 21. The RF unit 23 is connected to the processor 21, and transmits and/or receives RF signals. The BS 10 and/or the UE 20 may include a single antenna or multiple antennas. If at least one of the BS 10 and the UE 20 includes multiple antennas, the wireless communication system may be referred to as a multiple input multiple output (MIMO) system.

While the UE processor 21 enables the UE 20 to receive signals and can process other signals and data, and the BS processor 11 enables the BS 10 to transmit signals and can process other signals and data, the processors 21 and 11 will not be specially mentioned in the following description. Although the processors 21 and 11 are not specially mentioned in the following description, it should be noted that the processors 21 and 11 can process not only data transmission/reception functions but also other operations such as data processing and control.

Layers of a radio protocol between the UE 20 and the BS 10 and a wireless communication system (network) may be classified into 1st layer L1, 2nd layer L2 and 3rd layer L3 based on the 3 lower layers of the OSI (open system interconnection) model well known to communication systems. A physical layer belongs to the 1st layer and provides an information transfer service via a physical channel. RRC (radio resource control) layer belongs to the 3rd layer and provides control radio resources between UE and network. The UE 20 and the BS 10 may be able to exchange RRC messages with each other through a wireless communication network and RRC layers.

A CoMP (Coordinated Multi Point Transmission and Reception, coordinated multipoint) operation based on a terahertz (THz) communication system is a system that operates at a frequency band higher than a target frequency band (under 100 GHz) of a legacy communication system (e.g., LTE or 5G), so that the channel environment different from that of the legacy communication system may occur in the CoMP operation. A method for reducing a channel state information (CSI) feedback required for the CoMP operation in consideration of consistency between unique THz channel characteristics and beam-related information will hereinafter be described.

One of the largest features of terahertz (THz) propagation is that there is little loss of transmission of a material such as dielectrics. Table 1 shows representative material characteristics at 1 THz.

TABLE 1

| Material Type | Optical Property |
|---|---|
| liquid water | high absorption (α ≈ 250 cm⁻¹ at 1 THz) |
| metal | high reflectivity (>99.5% at 1 THz) |
| plastic | low absorption (α < 0.5 cm⁻¹ at 1 THz) |
| | low refractive index (n ≈ 1.5) |
| semiconductor | low absorption (α < 1 cm⁻¹ at 1 THz) |
| | high refractive index (n ~ 3-4) |

TABLE 2

| Material | Refractive index | Power absorption(Cm⁻¹) |
|---|---|---|
| Fused Silica | 1.952 | 1.5 |
| Sapphire | n₀ = 3.070 | 1 |
| | nₑ = 3.415 | |
| Intrinsic Ge | 4.002 | 0.5 |
| High-res GaAs | 3.595 | 0.5 |
| Quartz | n₀ = 2.108 | 0.1 |
| | nₑ = 2.156 | |
| High-res Si | 3.418 | 0.05 |

In Tables 1 and 2, the absorption coefficient (a) relates to an imaginary part (k) of a complex refraction index (n̅=n+jk). Here, a is denoted by α=4πk/λ, where λ is a wavelength in a free space. Transmission to thickness of any material can be denoted by L=e^{-αx}. Here, ‘x’ is the distance from a surface of the material to a certain depth, and L is a value indicating how much loss has occurred based on the value of 1.

Basically, the higher a frequency band, the shorter a wavelength of propagation waves. As a result, the capability of improving a beam resolution using multiple arrays may increase.

If beam steering based on improvement of beam resolution is required, and if a phase shifter is used in each array element to control the beam steering, it is necessary to increase precision of the phase shifter at a front end when designing an antenna. Phase shifter design is in progress at over 100 GHz. In order to increase beam directivity, a method for increasing directivity using a dielectric lens designed in consideration of THz material characteristics has been researched and developed. For example, an extended hemispherical lens has been developed as a THz antenna design.

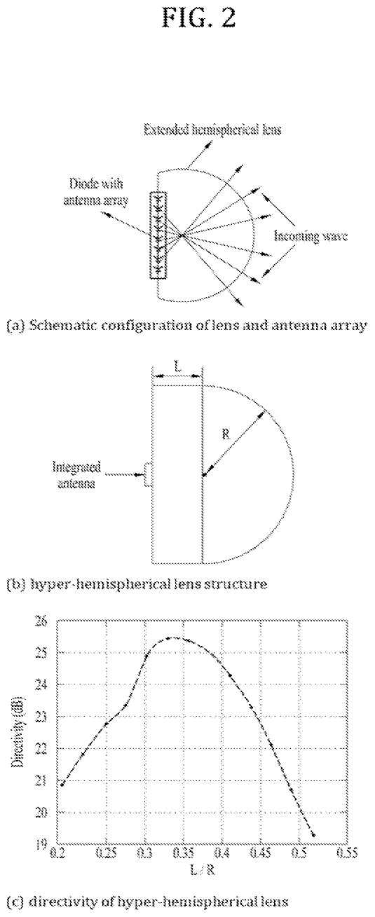

FIG. 2 is a schematic diagram illustrating a hyper-hemispherical lens and directivity of the hyper hemispherical lens.

Due to the advent of a lens antenna, plane waves can converge onto a certain point, and this point is defined as a focal point.

FIG. 2 illustrates the lens effect caused by doping of an antenna itself. The antenna can be designed independently using either the lens or a mirror formed of a material that generates strong reflection, and application of such antenna design can be used. The lens antenna formed in a special convex lens shape may be used to increase directivity or may be used for beam steering. The mirror can be applied in a form specialized for beam steering.

FIG. 3(a) is a schematic diagram illustrating an example of a THz lens, FIG. 3(b) is a schematic diagram illustrating an example of a THz dielectric mirror, and FIG. 3(c) is a schematic diagram illustrating an example of a THz antenna portion (or a THz antenna unit).

FIG. 3(a) is a diagram illustrating an example of a convex lens having good transmittance, and FIG. 3(b) is a diagram illustrating an example of a parabolic mirror having good reflectivity.

THz Beam Steering with Lenses

The following method is basically considered to be beam steering in the antenna structure including one or more THz lenses.
Beam conversion through steering of either a mechanical external lens or a feeder
Switching of beam direction through deformation of physical properties of lenses
Selection of arrays in consideration of positional relationship between the lenses and the antenna arrays

Generally, various mechanical methods have been developed and introduced, for example, a method of using scanning mirrors, a method of using rotating prisms, a method of using piezo-actuators, a method of using a microelectromechanical systems (MEMS) mirror, and the like. The following description relates to a method of moving the position of each of the lenses.

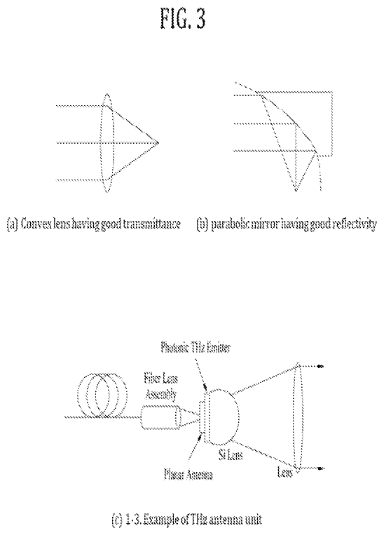

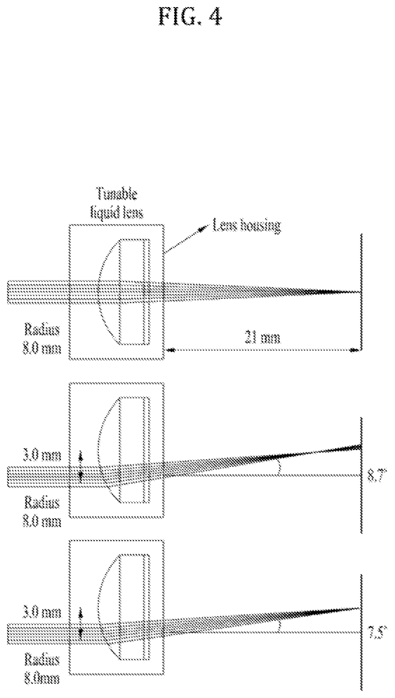

FIG. 4 is a conceptual diagram illustrating beam steering depending on the size and movement of the lenses.

A detailed description of FIG. 4 is illustrated in the following Table 3.

TABLE 3

(a) A 2 mm collimated beam is focused to an image
plane using a centered lens
with radius of curvature 8.0 mm.
(b) A lens is decentered by 3.0 mm from the optical axis,
resulting in steering and defocusing of the beam using 8
mm radius of curvature. The steering angle is 8.7.
(c) The curvature of a variable focal length lens is
adjusted to 8.8 mm to minimize the
spot size, which results in a shift of the
steering angle from 8.7 to 7.5.

A method of performing beam steering using movement of the lenses and movement of the antenna feeder may be unexpectedly restricted according to antenna implementation of the UE or the BS, each of which has a steering available range covering such antennas. As a result, there may arise various problems, for example, high complexity, alignment sensitivity, low reliability, etc.

If the time required for mechanical beam steering is defined as the time required to change the current beam to the next beam, various times may appear according to various implementations.

In general, although the steering range based on the mechanical beam steering method can be expressed in various ways according to various implementations, the steering range based on the mechanical beam steering method basically has physical operational restriction, so that the mechanical beam steering method may have a longer transition operation time than the non-mechanical beam steering method. As representative examples of non-mechanical methods, various methods are being discussed, for example, a first method for changing beam directivity in a manner that material characteristics are electrically or magnetically changed to others using specific materials through which physical characteristics of the lenses can be changed, a second method for adjusting the direction of transmission propagation either by changing the position of each element included in the antenna array bonded to the lens or by changing the position of a signal projected onto the lens, and the like.

In general, metamaterials having a refractive index that is changed through electrical or magnetic deformation, can be used in the lens antenna so as to perform beam steering through the change in electromagnetics.

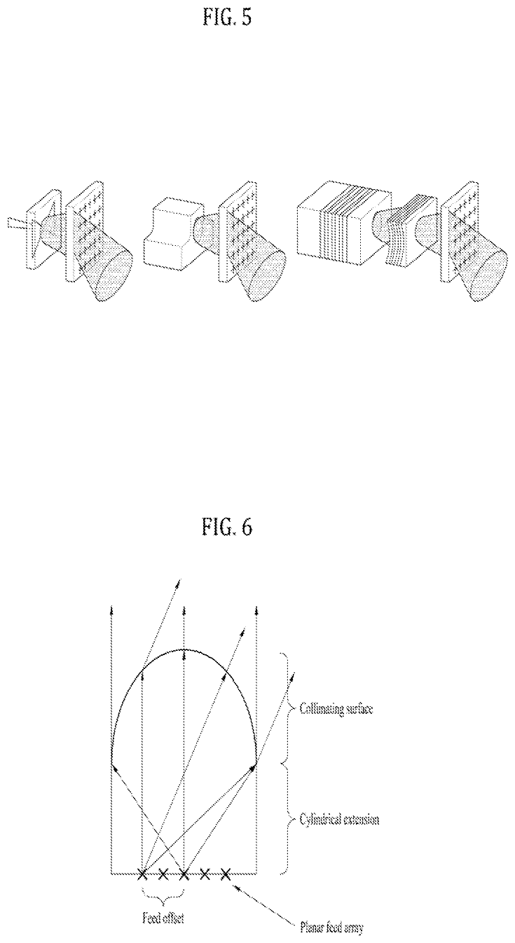

FIG. 5 is a conceptual diagram illustrating integration compatibility of the presented (or proposed) beam-steering metasurface.

The proposed metasurface may be disposed on the output surface of millimeter waves/terahertz(THz)/far-infrared-electromagnetic radiation sources such as a photoconductive THz source (a), a solid-state waveguide laser (b), and an external cavity surface emitting laser (VECSEL) (c) for controlling beam directivity. For example, when a secondary dimensional array of resonant metasurface unit cells is disposed on an electrically adjustable substrate, a current of each metasurface unit cell is controlled so that a resonant frequency and transmission (Tx) electromagnetic waves can be controlled.

By selecting elements of the array attached to the lens using the non-mechanical method, beam steering can be carried out. However, as the beam steering angle increases, a focusing performance and a beam gain can decrease.

FIG. 6 is a conceptual diagram illustrating beam steering with an integrated lens antenna.

In order to address the issues in which the focusing performance and the beam gain are reduced in proportion to the increasing beam steering angle, it may be possible to use a method for surrounding the lens with an inner reflected absorber and a method of using an array that is not formed in a non-planar substrate shape as shown in FIG. 6.

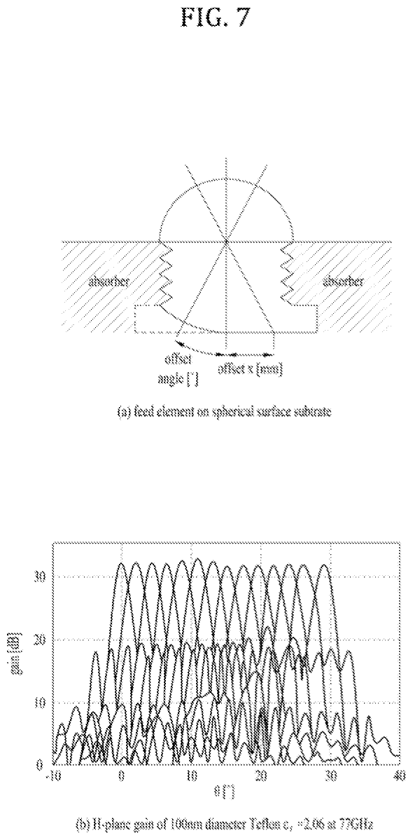

FIG. 7 is a conceptual diagram illustrating a 77 GHz extended hemispherical lens antenna including a WR-10 open waveguide feed.

However, the beam steering range through array selection is limited. Implementation technology for breaking through such beam steering range limitation should be further developed and evolved.

THz Pulse Generation (Photonic Source Based)

When using a photonic source (i.e., an infrared band source) in the process of generating THz pulses, a method for generating a photonic source using the infrared lasers (having about 70fs sampling resolution) and then modulating the generated photonic source into the THz band is mainly utilized. A device called an O/E converter can be expressed as follows.

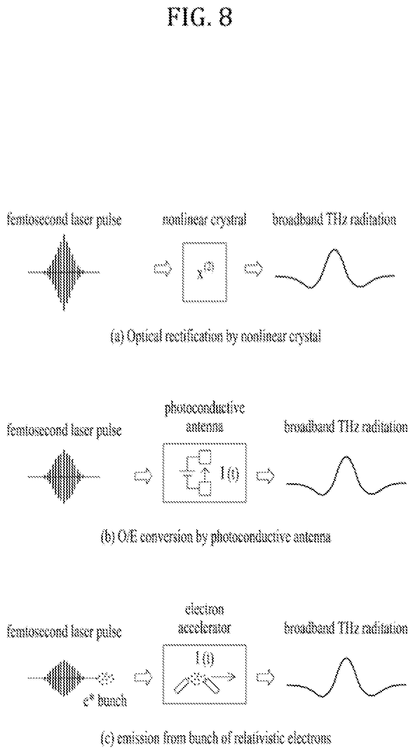

FIG. 8 is conceptual diagram illustrating an example of THz generation by photonic pulses.

The length of THz pulses generated in a shape shown in FIG. 8 may extend to the range of about femtosecond (fs)˜few picosecond (ps). In contrast, when viewed from outdoors, a bandwidth (BW) can be classified into a plurality of available BW ranges on the basis of an attenuation reference of 10\hat{ }2 dB/km within the spectrum extending to 1 THz.

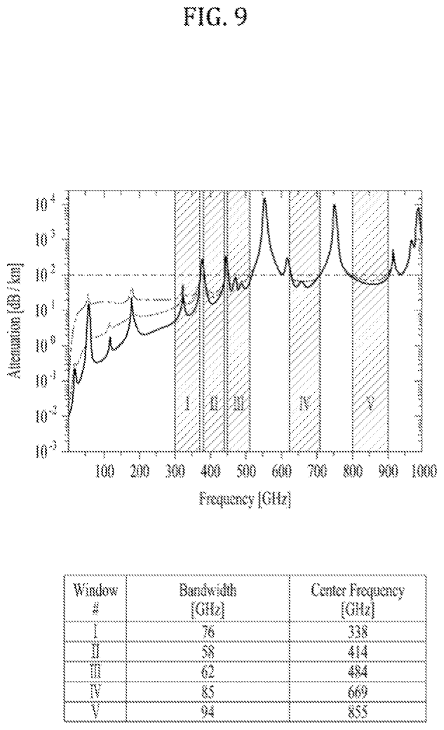

FIG. 9 is a conceptual diagram illustrating 1THz outdoor-based available bands.

Assuming that the THz pulse length is set to a length of about 50 ps on the basis of one carrier, the THz pulse length may have a bandwidth (BW) of about 20 GHz. When considering the length of one pulse on the basis of one transmission (Tx) unit, a gap time may be considered significantly long from the viewpoint of a framework. Therefore, it may be preferable that a resource transmission method for THz beam management in view of transmission (Tx) efficiency be processed at one time using a lump of transmission (Tx) resources for beam management and be processed for a long period of time.

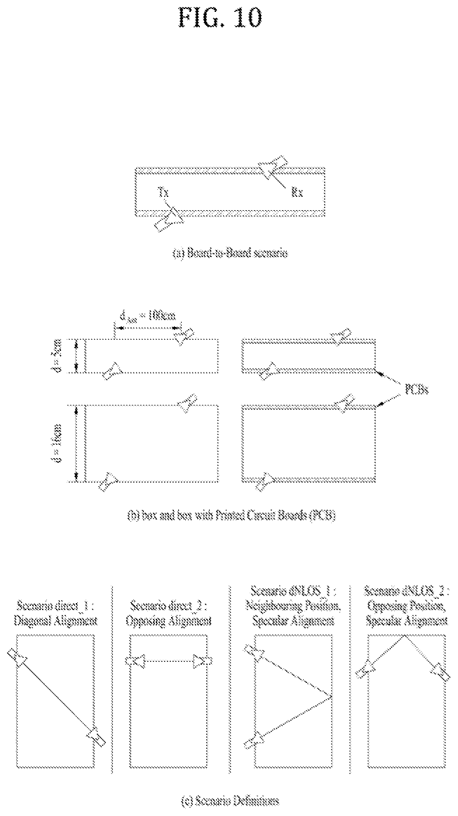

FIG. 10 is a conceptual diagram illustrating THz channel measurement (270-320 GHz).

FIG. 10 illustrates THz delay spread (270-320 GHz) of the inter-device communication case. The details of FIG. 10 can be represented by the following Table 5.

TABLE 5
For Direct Transmission, a diagonal positioning of Tx and Rx, corresponding to the
scenario direct_1, and a straight connection between directly opposing Tx and Rx,
corresponding to scenario direct_2, have been measured. For the mode of Directed NLOS
Transmission, communication between two antennas mounted on the same surface via a
guided reflection on the opposing wall, corresponding to scenario dNLOS_1, and
transmission between two opposing antennas via a reflection on a wall perpendicular to
both antenna mounts, corresponding to scenario dNLOS_2, have been measured.
Analogous to 4.2.1, each scenario has been measured inside a large and a small
environment, the dimensions of which can be found in [4.3]. Also, the environment was
measured in two different configurations, with the first consisting of a full plastic
environment and the second being equipped with two printed circuit boards at the front-
and backside. This leads to a total number of four scenario realizations per scenario
definition which are summarized exemplarily for scenario direct_1 in FIG. 4.2 in the
above sub-chapter.

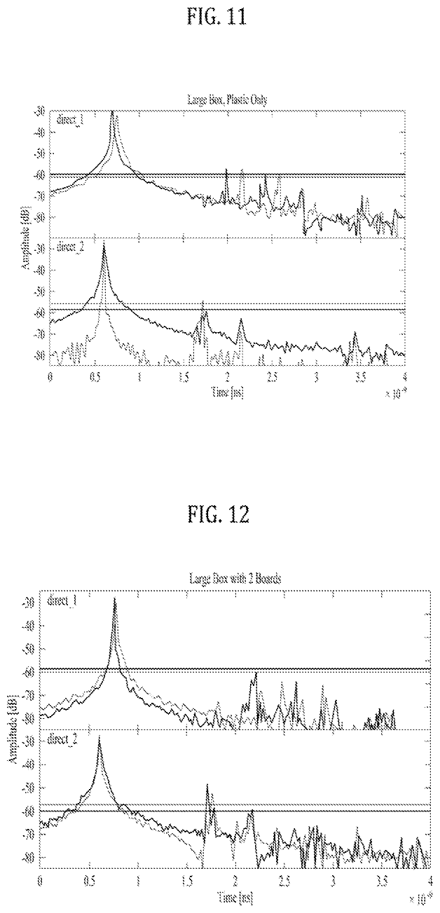

FIGS. 11 to 14 illustrate channel impulse response (CIR) values measured in a direct transmission scenario for implementation of all four scenarios.

In each of FIGS. 11 to 14, the upper drawing shows the measurement result of a first direct scenario, and the lower drawing shows the measurement result of a second direct scenario. Each of the first and second direct scenarios was measured through two measurement actions denoted by two types of curves (i.e., bold solid lines and thin solid lines). In FIGS. 11 to 14, the horizontal line may represent a threshold value that is −30 dB lower than the strongest signal component. The threshold value may be used to calculate a subsequent RMS delay spread.

The details of FIGS. 11 to 14 can be expressed by the following Table 6.

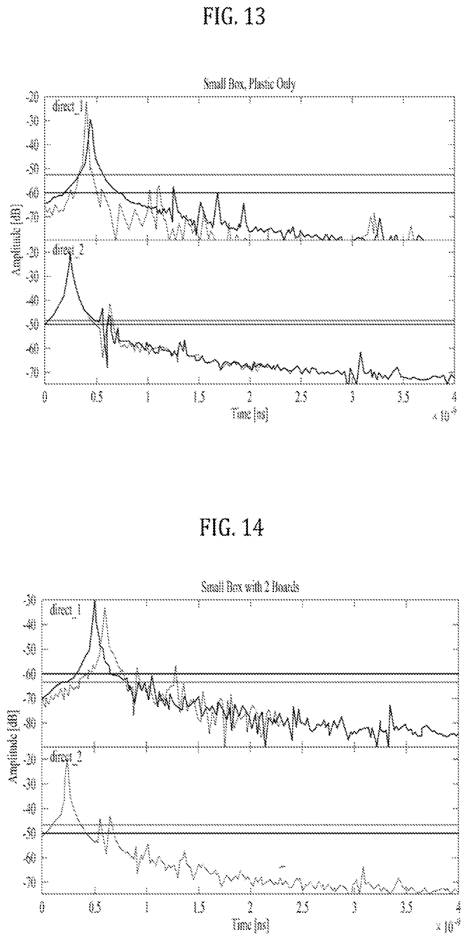

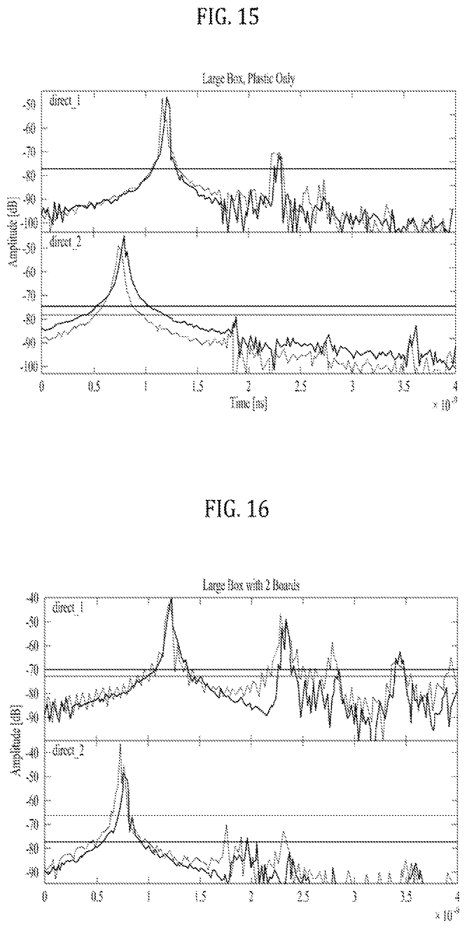

TABLE 6
For the large plastic box, it is observed that one dominant propagation path exists in the
case of board-to-board communications with no obstructions. Its amplitude generally lies
20 dB over that of the strongest echo path; most multipath components
even vanish below the previously defined threshold.
When the scenario is equipped with printed circuit boards, it is observed that the general
characteristics of the channel do not change. A clearly distinct main pulse remains visible
while the amplitudes of the echo paths remain in the order of the −30 dB threshold.
In a smaller environment, the echo clusters arrive earlier compared to the more spacious
environment, thus the CIR has a temporally more compact form. The amplitudes of the
echo paths remain at roughly the same level as observed for the large environment.
Again, inserting printed circuit boards into the environment does not much influence the
channel behaviour. However, it must be noted that the amplitudes for the diagonal
transmission in scenario direct_1 drop from between −20 dB and −30 dB in FIG. 13 to
between −30 dB and −40 dB in FIG. 15. This is most likely due to the fact that part of the
first Fresnel Zone is blocked by building parts on the PCB surface in case of the narrow
environment; however, no additional pulse broadening is observed from this. Overall, the
presence of printed circuit boards does not seem to have a significant impact to the direct
line-of-sight communication channel; compared to the effects already observed for the
plastic box, the multipath characteristics are not increased due to the insertion of PCBs.

Table 7 summarizes, as a performance index for temporal characteristics of a Line Of Sight (LOS) channel, the RMS delay spread that is calculated from the measurement values for the threshold value of −30 dB as defined above.

The details of the following Table 7 are described with reference to the following Table 8.

TABLE 8
One important characteristic of the presented values is their sensitivity regarding the
level of the defined threshold. Comparing the delay spread values for scenario direct_1
in the small box with ABS (green rectangle) to the values in the small box equipped
with PCBs (red rectangle), it strikes that the value grows by a factor of six for the
measurement corresponding to the green curve in FIGURE but shrinks by a factor of
two for the measurement corresponding to the red curve when PCBs are inserted.
Having a closer look at FIG. 13 and FIG. 15 reveals that this is due to the fact that
some multipath components (marked with blue circles) exceed the defined threshold
slightly while others don't. Even though the overall characteristic of the impulse
responses is the same in both cases, the calculated delay spreads suggest strong and also
contradicting changes in the temporal channel behaviour. A consequence of this
observations is that the channel model under development should be based on ray-
tracing simulations and accompanied by verification measurements. Since there is no
noise present in the case of simulations and the temporal position of the multipath
components is exactly known, the definition of a threshold for e.g. delay spread
calculations becomes obsolete.

FIGS. 15 to 18 illustrate CIR values measured in direct NLOS (Non Line Of Sight) transmission scenario for implementation of all four scenarios.

The details of FIGS. 15 to 18 are described below with reference to the following Table 9.

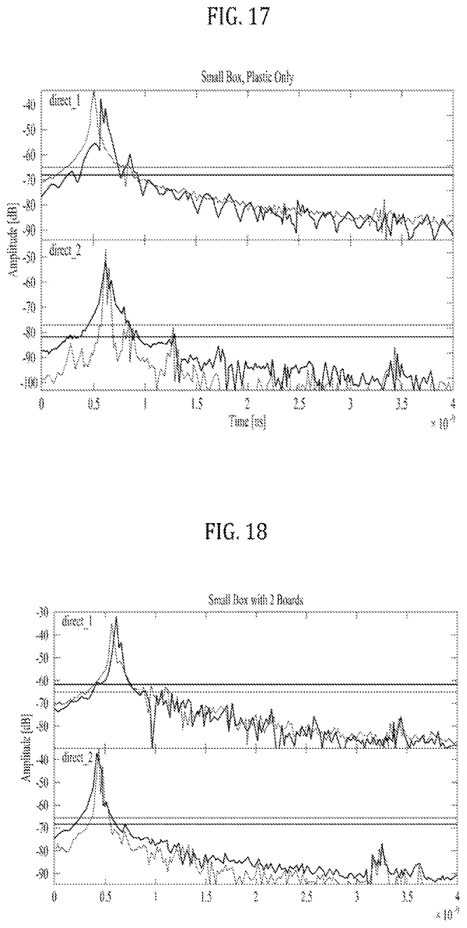

TABLE 9
Observing the results for the large environment, it is noticed that the main signal is clearly
broadened due to the reflection on the plastic casing of the box.
Apart from this significant difference to the LOS scenario, the multipath characteristics
remain similar to the direct transmission case; it should however be noted that some
rather strong multipath components are present in scenario dNLOS1.
Inserting printed circuit boards into the environment may change the channel behaviour
drastically for directed NLOS communications as seen in the above part
of FIG. 17. As the guided reflection takes place via a PCB surface now, the pulse
broadening becomes more severe for the main pulse. In addition, the echo components
increase in amplitude to la level of −5 dB below the main signal. For scenario dNLOS_2
the effects are much less significant as the reflection surface (short side-wall of the box)
is still an ABS layer.
Looking at the results for the small boxes, it can be seen that, analogous to the case of
directed communications, the temporal structure of the multipath components becomes
more compact. For the main signal, a slight increase of the pulse broadening of the main
pulse is observed compared to the large box measurement. This is due to the fact that a
the larger reflection angle, resulting from the reduced distance between antennas and
reflecting wall, leads to a longer path difference of the reflection processes at front- and
backside of the reflecting plastic layer. Details regarding this behaviour can also be found
in [4.2].
From the measurement results of the small box equipped with PCBs, it becomes obvious
that the impact of PCBs to the channel becomes less significant if the propagation
environment gets narrower. However, a temporal spread of the main signal that stems
from the scattering processes from the building parts throughout the board surface
remains a main channel characteristic.
Concludingly, it is observed that the characteristics of directed NLOS communications
vary significantly from those of the direct communications case. The guided reflection
process impinges a pulse broadening of the main signal for both plastic and PCB guided
reflections; moreover, the presence of scattering PCB surfaces has an impact on the
temporal profile of the channel impulse response, especially in spacious environments.

The following Table 10 shows the RMS delay spread calculation result for the indicated NLOS communication scenario. Table 10 shows the RMS delay spread for the directed NLOS transmission (Tx) measurement.

TABLE 10

| | Large | Small | Large | Small |
|---|---|---|---|---|
| | ABS | ABS | PCB | PCB |
| dNLOS_1, red | 0.367 ns | 0.099 ns | 0.758 ns | 0.122 ns |
| dNLOS_1, green | 0.245 ns | 0.115 ns | 0.650 ns | 0.047 ns |
| dNLOS_2, red | 0.072 ns | 0.036 ns | 0.026 ns | 0.027 ns |
| dNLOS_2, green | 0.085 ns | 0.129 ns | 0.139 ns | 0.069 ns |

Considering the measurement results described in the paragraphs 4.2.1 and 4.2.2, the scientific foundation for deriving the stochastic channel model has been established.
The process of deriving channel characteristics from the measurement result may include many problems, for example, the presence of noise, the influence of IFFT leakage, the unknown location of multipath components included in the measured signal, and the like. Thus, the ray tracing approach method is selected to create channel statistics.
Various channel characteristics may appear due to different operation modes, which should be described by separate channel statistics for a separate use case.

When considering the THz channel to be a higher band in unique characteristics of the present disclosure, there is a high possibility that delay profile characteristics on a time axis are composed of one or two clusters. Although the delay profile characteristics are composed of two clusters, there is a high possibility that a difference in power between the second cluster and the LoS cluster is approximately about 30 dB. In this case, when using a sharper beam as compared to the legacy system, assuming that a beam is well directed to a first AoA (Angle of Arrival), the second cluster is likely to be almost invisible. Thus, if the THz frequency increases more than the above measurement band of 300 GHz, the number of channel ranks will be at least 1 or a maximum of 2.

For this reason, feedback data (e.g., CSI-RS Resource Indicator (CRI), precoding matrix indicator (PMI), channel quality indicator (CQI), Layer 1 reference signal received power (L1-RSRP), or W1 of codebook) capable of deriving channel information (e.g., AoD (angle of departure), average AoD, AoA, average AoA, or delay profile of clusters) and beam information may have significant consistency in the THz region.

That is, assuming that the UE measures the AoA having received the strongest cluster at a link between a certain THz base station (BS) and the THz UE, the UE may estimate the AoD corresponding to the measured AoA, and this means that there is a high possibility that the estimated AoD is very similar to the AoD transmitted from the actual THz BS.

The following Table 11 relates to CSI feedback described in the NR standard (3GPP TS 38.214).

TABLE 11
The CQI indices and their interpretations are given in Table 5.2.2.1-2 for reporting CQI
based on QPSK, 16QAM and 64QAM. The CQI indices and their interpretations are
given in Table 5.2.2.1-3 for reporting CQI based on QPSK, 16QAM, 64QAM and
256QAM.
Based on an unrestricted observation interval in time unless specified otherwise in this
Subclause, [and an unrestricted observation interval in frequency-TBD], the UE shall
derive for each CQI value reported in uplink slot n the highest CQI index which
satisfies the following condition:
A single PDSCH transport block with a combination of modulation scheme,
target code rate and transport block size corresponding to the CQI index, and occupying
a group of downlink physical resource blocks termed the CSI reference resource, could
be received with a transport block error probability not exceeding:
0.1, if the higher layer parameter CQI-table configures Table 5.2.2.1-2, or Table
5.2.2.1-3, or
a higher layer configured BLER-target, if the higher layer parameter CQI-table
configures Table 5.2.2.1-4.
If a UE is not configured with higher layer parameter MeasRestrictionConfig-time-
channel, the UE shall derive the channel measurements for computing CQI value
reported in uplink slot n based on only the NZP CSI-RS, no later than the CSI reference
resource, (defined in TS 38.211[4]) associated with the CSI resource setting.
If a UE is configured with higher layer parameter MeasRestrictionConfig-time-channel,
the UE shall derive the channel measurements for computing CSI reported in uplink
slot n based on only the most recent, no later than the CSI reference resource, occasion
of NZP CSI-RS (defined in [4, TS 38.211]) associated with the CSI resource setting.
If a UE is not configured with higher layer parameter MeasRestrictionConfig-time-
interference, the UE shall derive the interference measurements for computing CQI
value reported in uplink slot n based on only the CSI-IM and/or NZP CSI-RS for
interference measurement no later than the CSI reference resource associated with the
CSI resource setting.
If a UE is configured with higher layer parameter MeasRestrictionConfig-time-
interference the UE shall derive the interference measurements for computing the CQI
value reported in uplink slot n based on the most recent, no later than the CSI reference
resource, occasion of CSI-IM and/or NZP CSI-RS for interference measurement
(defined in [4, TS 38.211]) associated with the CSI resource setting.
For each sub-band index s, a 2-bit sub-band differential CQI is defined as:
Sub-band Offset level (s) = wideband CQI index ? sub-band CQI index (s)
The mapping from the 2-bit sub-band differential CQI values to the offset level is
shown in Table 5.2.2.1-1
A combination of modulation scheme and transport block size corresponds to a CQI
index if:
the combination could be signaled for transmission on the PDSCH in the CSI
reference resource according to the Transport Block Size determination described in
Subclause 5.1.3.2, and
the modulation scheme is indicated by the CQI index, and
the combination of transport block size and modulation scheme when applied to
the reference resource results in the effective channel code rate which is the closest
possible to the code rate indicated by the CQI index. If more than one combination of
transport block size and modulation scheme results in an effective channel code rate
equally close to the code rate indicated by the CQI index, only the combination with the
smallest of such transport block sizes is relevant.

In Table 11, Table 5.2.2.1-1 is shown in Table 12, Table 5.2.2.1-2 is shown in Table 13, and Table 5.2.2.1-3 is shown in Table 14.

TABLE 12
Table 5.2.2.1-1: Mapping sub-band differential
CQI value to offset level

| Sub-band differential CQI value | Offset level |
|---|---|
| 0 | 0 |
| 1 | 1 |
| 2 | ≥2 |
| 3 | ≤−1 |

TABLE 13

| CQI index | modulation | code rate × 1024 | efficiency |
|---|---|---|---|
| 0 | out of range | | |
| 1 | QPSK | 78 | 0.1523 |
| 2 | QPSK | 120 | 0.2344 |
| 3 | QPSK | 193 | 0.3770 |
| 4 | QPSK | 308 | 0.6016 |
| 5 | QPSK | 449 | 0.8770 |
| 6 | QPSK | 602 | 1.1758 |
| 7 | 16QAM | 378 | 1.4766 |
| 8 | 16QAM | 490 | 1.9141 |
| 9 | 16QAM | 616 | 2.4063 |
| 10 | 64QAM | 466 | 2.7305 |
| 11 | 64QAM | 567 | 3.3223 |
| 12 | 64QAM | 666 | 3.9023 |
| 13 | 64QAM | 772 | 4.5234 |
| 14 | 64QAM | 873 | 5.1152 |
| 15 | 64QAM | 948 | 5.5547 |

TABLE 14

| CQI index | modulation | code rate × 1024 | efficiency |
|---|---|---|---|
| 0 | out of range | | |
| 1 | QPSK | 78 | 0.1523 |
| 2 | QPSK | 193 | 0.3770 |
| 3 | QPSK | 449 | 0.8770 |
| 4 | 16QAM | 378 | 1.4766 |
| 5 | 16QAM | 490 | 1.9141 |
| 6 | 16QAM | 616 | 2.4063 |
| 7 | 64QAM | 466 | 2.7305 |
| 8 | 64QAM | 567 | 3.3223 |
| 9 | 64QAM | 666 | 3.9023 |
| 10 | 64QAM | 772 | 4.5234 |
| 11 | 64QAM | 873 | 5.1152 |
| 12 | 256QAM | 711 | 5.5547 |
| 13 | 256QAM | 797 | 6.2266 |
| 14 | 256QAM | 885 | 6.9141 |
| 15 | 256QAM | 948 | 7.4063 |

Tables 15 and 16 show details of CSI reporting using a PUSCH in the NR standard (3GPP TS 38.214).

TABLE 15
A UE shall perform aperiodic CSI reporting using PUSCH on serving cell c upon
successful decoding.
An aperiodic CSI report carried on the PUSCH supports wideband, and sub-band
frequency granularities. An aperiodic CSI report carried on the PUSCH supports Type I
and Type II CSI.
A UE shall perform semi-persistent CSI reporting on the PUSCH upon successful
decoding of a DCI format 0_1 which activates a semi-persistent CSI trigger state. DCI
format 0_1 contains a CSI request field which indicates the semi-persistent CSI trigger
state to activate or deactivate. Semi-persistent CSI reporting on the PUSCH supports
Type I and Type II CSI with wideband, and sub-band frequency granularities. The
PUSCH resources and MCS shall be allocated semi-persistently by an uplink DCI.
CSI reporting on PUSCH can be multiplexed with uplink data on PUSCH. CSI reporting
on PUSCH can also be performed without any multiplexing with uplink data from the
UE.
Type I CSI feedback is supported for CSI Reporting on PUSCH. Type I sub-band CSI is
supported for CSI Reporting on the PUSCH. Type II CSI is supported for CSI Reporting
on the PUSCH.
For Type I and Type II CSI feedback on PUSCH, a CSI report comprises of two parts.
Part 1 is used to identify the number of information bits in Part 2. Part 1 shall be
transmitted in its entirety before Part 2 and may be used to identify the number of
information bits in Part 2.
For Type I CSI feedback, Part 1 contains RI (if reported), CRI (if reported), CQI for the
first codeword.
Part 2 contains PMI and contains the CQI for the second codeword when RI > 4.
For Type II CSI feedback, Part 1 has a fixed payload size and contains RI, CQI, and an
indication of the number of non-zero wideband amplitude coefficients per layer for the
Type II CSI (see sub-clause 5.2.2).
The fields of Part 1 - RI, CQI, and the indication of the number of non-zero wideband
amplitude coefficients for each
layer ? are separately encoded. Part 2 contains the PMI of the Type II CSI. Part 1 and 2
are separately encoded.
A Type II CSI report that is carried on the PUSCH shall be computed independently from
any Type II CSI report that is carried on the PUCCH formats 1, 3, or 4 (see sub-clause
5.2.4 and 5.2.2).
When the higher layer parameter ReportQuantity is configured with one of the values
‘CRI/RSRP’ or ‘SSBRI/RSRP’, the CSI feedback consists of a single part.
For both Type I and Type II reports configured for PUCCH but transmitted on PUSCH,
the encoding scheme follows that of PUCCH as described in Subclause 5.2.4.
When CSI reporting on PUSCH comprises two parts, the UE may omit a portion of the
Part 2 CSI. Omission of Part 2 CSI is according to the priority order shown in Table
5.2.3-1, where is the number of CSI reports in one slot. Priority 0 is the highest priority
and priority is the lowest priority and the CSI report numbers correspond to the order of
the associated ReportConfigID. When omitting Part 2 CSI information for a particular
priority level, the UE shall omit all of the information at that priority level.
Table 5.2.3-1: Priority reporting levels for Part 2 CSI

Table 5.2.3-1 in Table 15: Priority reporting levels for Part 2 CSI can be represented by the following Table 16.

TABLE 16

Priority 0:
Part 2 wideband CSI for CSI reports 1 to
Priority 1:
Part 2 subband CSI of even subbands for CSI report 1
Priority 2:
Part 2 subband CSI of odd subbands for CSI report 1
Priority 3:
Part 2 subband CSI of even subbands for CSI report 2
Priority 4:
Part 2 subband CSI of odd subbands for CSI report 2
.
.
.
Priority 2N_{Rep}-1:
Part 2 subband CSI of even subbands for CSI report N_{Rep}
Priority 2N_{Rep}:
Part 2 subband CSI of odd subbands for CSI report N_{Rep}

TABLE 17
When the UE is scheduled to transmit a transport block on PUSCH
multiplexed with a CSI report, Part 2 CSI is omitted only when the
UCI code rate for transmitting all of Part 2 would be greater than a
threshold code rate ^{C}T, where

| | |
|---|---|
| | ${ }^{C} T = \frac{{}^{C} MCS}{{β}_{offset}^{CSI - 2}}$ |
| - | ^{C}MCS is the target PUSCH code rate from Table 6.1.4.1-1. |
| - | β_{offset}^{CSI-2} is the CSI offset value from Table 9.3-2 of [6, TS 38.213]. |

Part 2 CSI is omitted level by level, beginning with the lowest priority
level until the lowest priority level is reached which causes the UCI
code rate to be less than or equal to ^{C}T.
When part 2 CSI is transmitted on PUSCH with no transport block,
lower priority bits are omitted until Part 2 CSI code rate is below a
threshold code rate c_{T} lower than one, where
${ }^{C} T = \frac{{β}_{offset}^{CSI - part 1}}{{β}_{offset}^{CSI - part 2}} \cdot {r}_{CSI - 1}$
-β_{offset}^{CSI-part1} and β_{offset}^{CSI-part2} are the CSI offset value from Table 9.3-2
of [6, TS 38.213].
-[^{r}CSI-1 is based on the code rate calculated at UE or signaled in DCI.]

The following Table 18 shows details of CSI reporting using a PUCCH in the NR standard (3GPP TS 38.214).

TABLE 18
A UE is semi-statically configured by higher layers to perform periodic CSI Reporting
on the PUCCH. A UE can be configured by higher layers for multiple periodic CSI
Reports corresponding to one or more higher layer configured CSI Reporting Setting
Indications, where the associated CSI Measurement Links and CSI Resource Settings are
higher layer configured. Periodic CSI reporting on PUCCH formats 2, 3, 4 supports Type
I CSI with wideband granularity.
A UE shall perform semi-persistent CSI reporting on the PUCCH upon successfully
decoding a selection command [10, TS 38.321]. The selection command will contain one
or more Reporting Setting Indications where the associated CSI Measurement Links and
CSI Resource Settings are configured. Semi-persistent CSI reporting on the PUCCH
supports Type I CSI. Semi-persistent CSI reporting on the PUCCH format 2 supports
Type I CSI with wideband frequency granularity. Semi-persistent CSI reporting on
PUCCH formats 3 or 4 supports Type I Sub-band CSI and Type II CSI with wideband
frequency granularity.
When the PUCCH carry Type I CSI with wideband frequency granularity, the CSI
payload carried by the PUCCH format 2 and PUCCH formats 3, or 4 are identical and
the same irrespective of RI (if reported), CRI (if reported). For type I CSI sub-band
reporting on PUCCH formats 3, or 4, the payload is split into two parts. The first part
contains RI (if reported), CRI (if reported), CQI for the first codeword. The second part
contains PMI and the CQI for the second codeword when RI > 4.
A semi-persistent report carried on the PUCCH formats 3 or 4 supports Type II CSI
feedback, but only Part 1 of Type II CSI feedback (See sub-clause 5.2.2 and 5.2.3).
Supporting Type II CSI reporting on the PUCCH formats 3 or 4 is a UE capability. A
Type II CSI report (Part 1 only) carried on PUCCH formats 3 or 4 shall be calculated
independently of any Type II CSI reports carried on the PUSCH (see sub-clause 5.2.3).
When the UE is configured with CSI Reporting on PUCCH formats 2, 3 or 4, each
PUCCH resource is configured for each candidate UL BWP.
A UE is not expected to report CSI with a payload size larger than 115 bits when
configured with PUCCH format 4.

The following Table 19 shows priority rules of the CSI report in the NR standard.

TABLE 19
CSI reports are associated with a priority value PriiCSI(y, k, c, s) =
2 · 16 · Ms · y + 16 · Ms · k + Ms · c + s where
y = 0 for aperiodic CSI reports to be carried on PUSCH, y = 1 for semi-persistent CSI
reports to be carried on PUSCH, y = 2 for semi-persistent CSI reports to be carried on
PUCCH and y = 3 for periodic CSI reports to be carried on PUSCH
k = 0 for CSI reports carrying L1-RSRP and k = 1 for CSI reports not carrying L1-
RSRP
c is the serving cell index
s is the ReportConfigIDD and Ms is the value of the higher layer parameter
maxNrofCSi-Reports.
A first CSI report is said to have priority over second CSI report if the associated
PriiCSI(y, k, c, s) value is lower for the first report than for the second report.
Two CSI reports are said to collide if the time occupancy of the physical channels
scheduled to carry the CSI reports overlap in at least one OFDM symbol and are
transmitted on the same carrier. When a UE is configured to transmit two colliding CSI
reports, the following rules apply (for CSI reports transmitted on PUSCH, as described
in Subclause 5.2.3; for CSI reports transmitted on PUCCH, as described in Subclause
5.2.4):
The CSI report with higher PriiCSI(y, k, c, s) value shall not be sent by the UE
If a semi-persistent CSI report to be carried on PUSCH collides with PUSCH data
transmission, the CSI report shall not be transmitted by the UE.

A detailed description of the priority rules of the CSI report in the NR standard can be summarized as shown in the following Table 20.

TABLE 20

| | Part 1 | Part 2 |
|---|---|---|
| Type-I CSI | RI (if reported) | PMI |
| feedback | CRI (if reported) | CQI for the 2^{nd} codeword |
| | CQI for the 1^{st} codeword | (RI > 4) |
| Type-II CSI | RI | PMI |
| feedback | CQI | |
| | Indication of the number | |
| | (non-zero wideband amplitude | |
| | coefficients per layer) | |

In order to basically increase the capacity, the THz communication system will require the inter-cell distance and/or the inter-TRP distance that is considered more dense than the legacy system (e.g., LTE, NR), it can be expected that many more THz BSs or TRPs (Transmission and Reception Points) will be required. In addition, the number of transmission/reception (Tx/Rx) beams per TRP can significantly increase much more than the legacy system. One link will basically result in a loss change due to movement of the UE, and transmission (Tx) power may be restricted in one link due to THz radiation limitations. Therefore, in order to increase reliability of one UE, it is necessary for the THz CoMP operation to be basically performed. A plurality of THz TRPs may receive CSI feedback information from the UE, and may exchange the received feedback information with each other or utilize the exchange result, so that the THz TRPs can perform various operations, for example, Joint transmission (JT), Coordinated scheduling (CS), Coordinated beamforming (CB), DPS (Dynamic port selection), etc. using the resultant information. In general, as the number of BSs or the number of THz TRPs increases, the number of links, each of which has to acquire CSI, increases, so that the number of CSI feedback times may also increase, resulting in an increase in CSI feedback overhead.

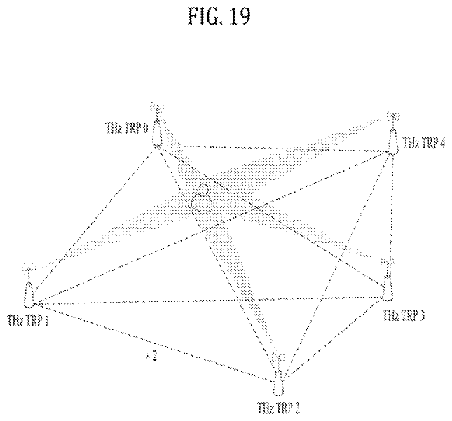

FIG. 19 is a conceptual diagram illustrating THz TRP arrangement and CoMP when viewed from indoors.

Referring to FIG. 19, in order to support CoMP for the corresponding UE by referring to the CSI feedback structure of the NR standard, CSI information of links related to THz TRP0, THz TRP1, THz TRP2, THz TRP3, and THz TRP4 is required as follows.
CSI Part 1: (R0, R1, R2, R3, R4), (CQI0, CQI1, CQI2, CQI3, CQI4)
CSI Part 2: (PMI0, PMI1, PMI2, PMI3, PMI4), if RI is set to 4 or more, CQI0′, CQI1′, CQI2′, CQI3′, and CQI4′ of a second codeword are given.

As described above, as a frequency band such as the THz band or the mmWave band increases, the number of dominant rays decreases. Certain UEs may recognize or estimate ray information (e.g., ray reception (Rx) direction (AoA), average AoA of AoAs having received the ray) through either a beam management CSI-RS or a reference signal (RS) for acquiring ray information. Also, assuming that the channel environment (THz environment) is associated with ray information and beam information, beam information can be acquired/estimated using the resultant information. Specifically, as the frequency band increases, there is a high possibility of high consistency between the direction of a reception (Rx) beam and the direction of reception (Rx) ray. The present disclosure proposes a method for reducing feedback information for either CSI about the plurality of TRPs or beam reporting about the plurality of TPRs based on the above-mentioned characteristics.

As an example, as shown in FIG. 19, there is a high possibility that the UE having a superior quality of a specific transmission (Tx) beam index ‘x’ (#x) in TRP0 has an excellent transmission (Tx) beam index y (#y) in TRP 1. Using the correlation characteristics between preferred beams of the plural TRPs can acquire not only preferred beam information for TRP0, but also preferred beam information for TRP1 even when the UE feeds back only the preferred beam information for TRP0 to the BS.

Although FIG. 19 assumes the environment in which the LoS ray is dominant for all TRPs for convenience, NLoS ray (or reflected ray) may be considered dominant for a specific TRP when there is a reflected known reflector. In addition, although the above-mentioned example has disclosed that the TRP0 beam and the TRP1 beam are one-to-one connected to each other, the scope or spirit of the present disclosure is not limited thereto, and it should be noted that one-to-multiple relationship may be defined/configured as necessary. In other words, if the preferred beam for TRP0 is denoted by #x, association information can be configured in the preferred beam for TRP1 in a manner that selection/reporting operation can be performed only in M beams (where M<N) from among all beams (#y_0, . . . , y_(N−1)). In this case, the amount of feedback information for TRP1 can be reduced from log N to log M by the UE. Although the above-mentioned idea has proposed the plurality of TRPs, the scope or spirit of the present disclosure is not limited thereto, and it should be noted that the idea can also be applied to different panels or beams of the same TRP (or different TRPs). For example, different beams may be applied to P-port CSI-RS at the same TRP, and the application result can be applied to the UE, and the BS may request a CSI feedback for each P-port CSI-RS resource from the UE. In a situation in which the above idea is extended and applied, when a PMI for the first CSI-RS resource is denoted by #x, association information can be configured in a manner that a PMI for the second CSI-RS resource can be selected from among #y_0, . . . , #y_(M−1) (where 1≤M≤N).

The PMI feedback may be identical in function to the PMI codebook subset restriction of the legacy system when viewed in an aspect of limiting non-associated PMIs that are not reported, rather than when viewed in an aspect of selecting a necessary PMI from among related PMIs. Assuming that the existing PMI codebook subset restriction indicates that unavailable PMIs not to be used are restricted when viewed from a specific TRP/BS, if the preferred PMI for a specific TRP/BS is a certain value, the codebook for selecting the preferred PMI for another TRP/BS can be restricted according to the selected PMI value. (That is, PMI codebook subset restriction where the restricted set is dependent on the selected PMI is used for the associated other CSI reporting)

In addition, the above-mentioned idea can be applied to a plurality of component carriers (CCs), a plurality of cells, or a plurality of bandwidth parts (BWPs). In general, although signals are transmitted at the same TRP, if the signals are different in frequency band from each other, the signals may have different types of preferred beam information. The degree of changing the beam/CSI according to the transmission (Tx) frequency band may be changed depending on both of the hardware configuration such as an antenna and a difference indicating how far the frequency band is located.

For example, when a signal of an adjacent band is transmitted using a multi-band antenna, although CC/BWP/Cell are different from each other, the beam and the CSI may be identical or similar to each other. In contrast, if hardware (e.g., an antenna, an amplifier, a phase shifter, etc.) of each band is independently implemented, or if there is a large difference between the frequency bands, association (or correlation) between the beam and the CSI may greatly decrease.

Assuming that the above idea is applied to the CC/BWP/Cell (or the serving cell), the preferred beam ID (or PMI) for a specific CC/BWP/Cell may be pre-associated with the preferred beam IDs (or PMIs) for another CC/BWP/Cell as needed. When the number of candidate beams for each CC/BWP/Cell is set to N, the UE configured for such association information may select a beam for the first CC/BWP/Cell from among N beams, and may report the selected beam to the BS. In contrast, the UE may select a beam for the second CC/BWP/Cell from among M beam IDs related to the preferred beam ID of the first CC/BWP/Cell, and may report the selected beam to the BS, so that the amount of feedback information can be reduced. Although the current NR system can determine information about whether the same/similar (analog) beam is applied to different BWPs/CCs to be spatial QCL (QCL Type D in TS 38.214) between SSB/CSI-RS resources that are transmitted through different BWPs/CCs, this means that one-to-multiple association information between DL reference signals (RSs) transmitted in different CCs/BWPs is provided as a kind of ON or OFF information, but a means capable of reducing the amount of reporting information through the one-to-multiple association information does not exist.

In addition, the present NR system does not provide a means of reducing the amount of CSI feedback information through CSI association information such as PMI between different BWPs/CCs.

Proposal 1

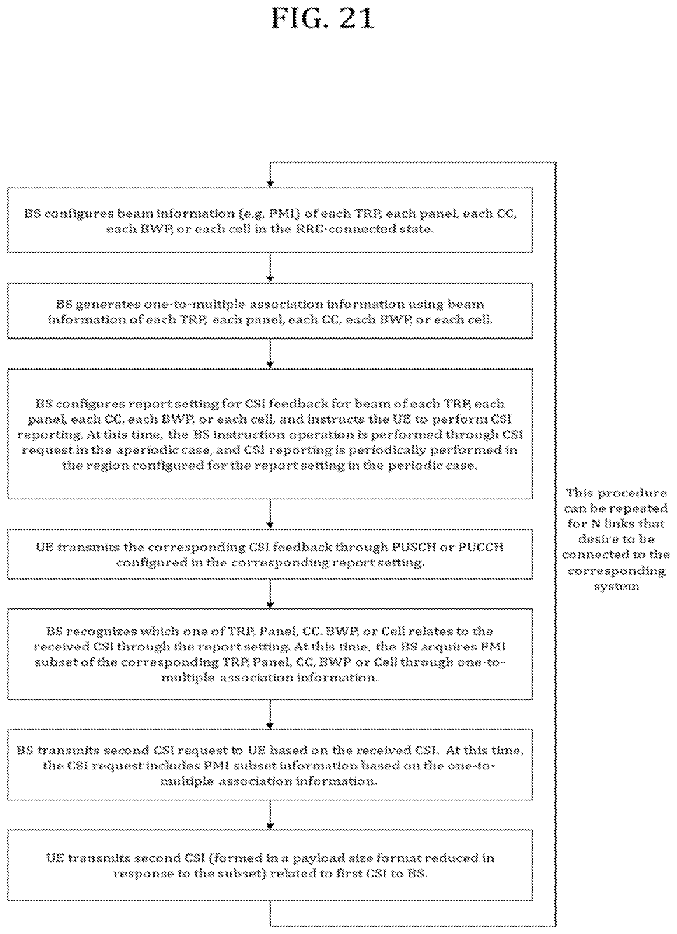

The BS may establish PMIs indicating beam directivity information for the UE connected to a link in each of TRP, Cell, CC, beam, and panel in the initial access or RRC-connected state through higher layer signaling or higher layer configuration. Thereafter, the BS may transmit the above-mentioned association information to the UE through RRC signaling, L2 (MAC-CE) signaling, and/or L 1 (DCI) signaling, and may configure the resultant information for the UE. The UE may transmit PMI and CQI, PMI and L1-RSRP, or PMI and L1-SINR, etc. to the BS using a PUCCH (Physical Uplink Control CHannel) or PUSCH (Physical Uplink Shared CHannel) allocated to reporting setting (or CSI reporting setting) corresponding to the corresponding TRP, Cell, CC, and panel. The order of utilizing association of only one resource connected to one reporting setting is shown FIG. 21.

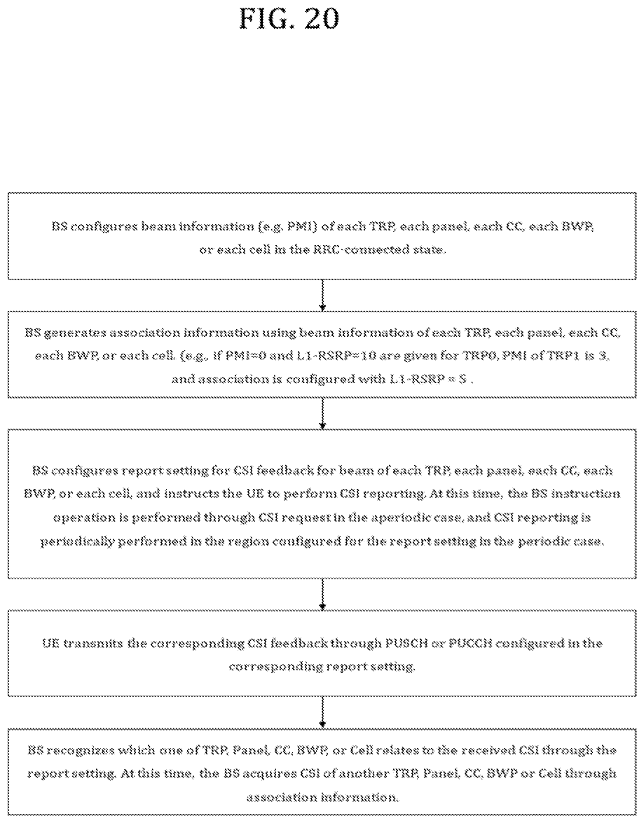

FIG. 20 is a flowchart illustrating the order of utilizing one-to-one connection between channel state information (CSI) and a single resource of a TRP, a panel, a component carrier (CC), a bandwidth part (BWP), or a cell.

Based on the order of utilizing CSI one-to-one association information shown in FIG. 20, a PMI and L1-RSRP, L1-SINR, or PMI and CQI, etc. corresponding to another reporting setting indicating another TRP, Cell, Panel, CC, BWP, etc. can be estimated using a PMI and LI-RSRP caused by one reporting setting through one-to-one association information.

The association information is configured in a manner that PMI, CQI, or L1-RSRP caused by the corresponding resource is associated with a PMI, CQI, or L1-RSRP value corresponding to resources of another TRP, Panel, CC, BWP, and Cell. Thus, assuming that N resources related to only one reporting setting are configured and a total number of PMIs expressed by one resource is set to N, a total of n×N pieces of association information is required. Accordingly, in order to reduce CSI payload configured as one reporting setting, there is a need for interconnected resources included in only one reporting setting to be associated with each other. As an example, assuming that the number of CSI-RS resources connected in the reporting setting is set to 5 and one CSI-RS is associated with only one CSI-RS selected from among the remaining four CSI-RSs, the size of a PMI from among necessary CSI feedback information can be reduced from “5×(log 2 N)” to “(4 Combination 1)×(log 2 N)”.

Since there is a possibility that the condition for establishing the above one-to-one association information is not suited to a high frequency band, it is necessary for the one-to-one association information to extend to one-to-multiple association information. In this case, in order to obtain the best beam information subset from among beam information subsets (i.e., PMIs subsets) for another TRP, Panel, CC, BWP, or Cell through beam information (PMI+CQI, or PMI+L1-RSRP) that is obtained through a first CSI request caused by one-to-multiple association information, the second CSI request may be designated as the reporting setting of the corresponding TRP, Panel, CC, BWP, or Cell. In association with the one-to-multiple association, the number of PMIs of the corresponding TRP, Panel, CC, BWP, or Cell, the number of CQIs of the corresponding TRP, Panel, CC, BWP, or Cell, or the number of L1-RSRPs of the corresponding TRP, Panel, CC, BWP, or Cell can be represented by a subset of a total number of PMIs, or a subset of the number of CQIs, or a subset of the number of L1-RSRPs, so that the size of CSI feedback payload can be reduced.

Therefore, in order to determine the payload size of a second CSI request and determine which subset beam will be indicated, there is a need for the BS to provide the one-to-multiple association information to the UE.

Proposal 2: Alternatives as a Method for Configuring the One-to-Multi Association Information

First Alternative (Alt 1): One-to-multiple association table may be utilized. The one-to-multiple association table may be configured as an RRC signal. For example, if the UE performs measurement and reporting at PMI0=3, CQI0=2, or L1-RSRP0=10 dB in a situation where a PMI for the resource index ‘0’ (Resource 0) of the TRP0 is defined as PMI0, if the table is configured at PMI1={5, 6, 7, 8} for Resource 0 at TRP1 in a situation in which PMI0=3 and CQI0=2 are configured in the association table, and if the UE receives a CSI request for the corresponding TRP1 or a CSI report by the report setting, payload of PMI1 can be transmitted with 2 bits. The corresponding CQI or L1-RSRP can be regarded as the corresponding PMI, and can be measured and reported.

Second Alternative (Alt 2): One-to-one association table can be utilized, but the range value can be set to the CSI transmission region (PUSCH/PUCCH) configured as the second CSI request or the second report setting on the basis of either the first reception PMI or the CQI or L1-RSRP value. In some embodiments, assuming that PMI0=3 and L1-RSRP=3 dB transferred by the UE are decided by either the first report setting or the first CSI request, the BS may understand ‘PMI2=6’ as the setting of TRP2 of the second report setting according to one-to-one association information between TRP0 and PMI0 (in a situation where PMI2=6 is associated with PMI1=2), the value of 2 indicating the PMI range for one-to-multiple association may be set to the second CSI request or the second report setting. The UE may re-adjust this PMI range value (i.e., PMI0 4, 5, 6, 7, 8→PMI′0 0, 1, 2, 3, 4, 5) on the basis of the range (±2) from PMI2=6 at the second CSI feedback, may allocate 3 bits to the PMI range value, and may thus transmit the value of PMI0.

FIG. 21 is a flowchart illustrating the order of utilizing one-to-multiple connection between CSI and a single resource of a TRP, a Panel, a CC, a BWP, or a Cell.

Basically, association information may assume that channel state information (CSI) between the UE and the BS is denoted by ‘LoS’ in the initial access state. In more detail, it is necessary for the CSI between the UE and BS to be set to LoS according to positional relationship between the UE and a TRP, Panel, CC, BWP, or cells. As a result, beam information can correctly recognize the direction of a beam of another TRP, Panel, CC, BWP, or Cell so that the beam information can be adjusted to be directed to the corresponding TRP, Panel, CC, BWP, or Cell. However, this association may be considered inappropriate for the link denoted by NLoS. Therefore, there is a need for the NLoS case to be determined, and there is a need for association between the non-collected TRP, Panel, CC, BWP and Cells to be determined.

Proposal 1 and Proposal 2 may be options for the LoS case. However, assuming that association information of Proposal 1 and association information of Proposal 2 can be applied after the BS and the UE have obtained the content of the Tx/Rx distance of the beam and the content of Tx/Rx beam information, association information of Proposal 1 and association information of Proposal 2 can be used irrespective of LoS/NLoS.

Proposal 3

In order to determine the presence or absence of NLoS between the BS and the UE and to determine whether to use the corresponding association information, the BS and the UE can operate according to the following alternatives (Alt)

First Alternative (Alt 1): The order of discriminating the NLoS according to LoS/NLoS decision of the UE

1. The BS may configure one-to-one association or one-to-multiple association using beam information of each of TRP, Panel, CC, BWP, and Cell.

2. CSI feedback indication message caused by either the first report setting or the CSI request for a target TRP, Panel, CC, BWP, or Cell is transferred from the BS. The UE having received the CSI feedback indication message may transmit first CSI feedback to the BS through a CSI feedback region (PUCCH/PUSCH) caused by either the first report setting for the target TRP, Panel, CC, BWP, or Cell or the CSI request.

3. The BS may instruct the UE to transmit the second CSI request caused by association information. This report setting connected to this CSI request may include specific information indicating which one of TRP, Panel, BWP, Cell, and CC relates to resource information connection, and may include the restriction indication subset information affected by either one-to-one association information or one-to-multiple association information and then transmit the resultant information (for example, when PMI0=1 and CQI0=3 are given, PMI3={4, 5, 6, 7} is obtained). That is, the above information may operate as a flag indicating whether target information will be transmitted either in the restricted PMI format or in the total PMI format. In addition, the UE may transmit the flag indicating whether the corresponding link resource is LoS or NLoS to the BS. Accordingly, in association with the second CSI request, 1-bit setting for this flag should be pre-configured in the report setting for the second CSI request.

4. The UE may search for the best PMI through resources connected to the second CSI report setting, and may also search for CQI, L1-RSRP, or L1-SINR corresponding to the best PMI. At this time, the UE can search for either the entire PMI set or the CQI, RI, L1-RSRP, or L1-SINR set of the TRP, Panel, CC, BWP, or Cell to which resources connected to the second CSI report setting are transmitted. The UE may compare the best PMI with the restricted PMI set and the CQI, L1-RSRP, L1-SINR set according to both of the CQI, L1-RSRP, or L1-SINR corresponding to the best PMI and the one-to-multiple association information. If the best PMI and the CQI, L1-RSRP, and L1-SINR corresponding to the best PMI are included in the restricted PMI set and the CQI, L1-RSRP, and L1-SINR set according to one-to-multiple association information, the best PMI and the CQI, L1-RSRP, and L1-SINR corresponding to the best PMI can be fed back to the BS according to the payload form requested by the second CSI request. If each of the restricted PMI set and the CQI, L1-RSRP, and L1-SINR set does not include the measured best PMI and the CQI, L1-RSRP, or L1-SINR corresponding to the measured best PMI, flag information indicating that the UE has appreciated that the above situation is denoted by NLoS can be transmitted to the BS.

5. The BS may decode the above flag, and may thus acquire the remaining CSI feedback information.

6. If the flag disclosed in the above section (4) indicates NLoS, the UE may not transmit the remaining CSI. Accordingly, the BS may understand that association information between links related to the TRP, Panel, CC, BWP, or Cell is improper through the received flag, and may retransmit the second CSI request to the UE. In this case, the feedback payload format of the retransmitted CSI request may be configured to cover both of the entire PMI and the CQI, L1-RSRP, and L1-SINR set.

7. If the flag is denoted by NLoS in the above section (6), the BS operation may consider the following description as one example in consideration of CSI reduction. That is, as one example, the CSI request of a specific link related to resources announced as NLoS is not transmitted again, and the specific link is not used. If the objective environment includes many more THz CoMP TRPs than those of the legacy system, the above-mentioned method can be considered available, and the above-mentioned method can be used in consideration of THz communication when viewed from indoors so that a sharper beam can be generated for coverage enhancement.

8. As a shortcoming of the above-mentioned method, the 1-bit flag is further added to each of the second to N-th CSI request as compared to the legacy system. If all flags are denoted by NLoS, payload may unavoidably increase by a predetermined number of bits (i.e., (N−1) bits).

Second Alternative (Alt 2): Dynamic payload size configuration and CSI feedback transmission according to the LoS/NLoS flag

1. The flag indicating LoS/NLoS may be configured and added to the report setting starting from the second CSI request (where the LoS/NLoS flag may be included in a payload header), the second CSI payload may have a conditional dynamic length.

A. If the LoS/NLoS flag is set to zero ‘0’ (that is, if the best PMI and the CQI, L1-RSRP, and L1-SINR corresponding to the best PMI are included in each of the PMI subset designated by association information and the CQI, L1-RSRP, or L1-SINR subset designated by association information), payload can be determined based on both of the restricted PMI subset caused by association information and the CQI, L1-RSRP, or L1-SINR subset.

B. If the LoS/NLoS flag is set to ‘1’ (i.e., NLoS) (that is, if the best PMI and the CQI, L1-RSRP, or L1-SINR corresponding to the best PMI are not identical to each of the PMI subset designated by association information and the CQI, L1-RSRP, or L1-SINR subset designated by association information), payload can be determined based on both of the entire PMI set and the CQI, L1-RSRP, or L1-SINR set.

Proposal 4

The BS may provide the UE with an indicator (e.g., W1 denotes the entire beam set indicating the long-term statistical PMI of a dual codebook) indicating beam information according to the report setting connected to each CSI resource, each CSI resource set, or each resource setting, or may provide the UE with the relationship equation (or association information) between PMI and channel information. That is, the relationship equation between beam information (e.g., PMI or W1) and channel information (e.g., DoA (departure of angle), average DoA, AoA (arrival of angle), average AoA, delay profiles, etc.) can be estimated from first resources and second resources, and the relationship equation can also be configured for the UE through higher layer signaling. Here, the first resources may be obtained from CSI resources transmitted at a specific TRP, Cell, CC, Beam, or Panel, may be obtained from a CSI resource set, or may be obtained from a resource setting configuration, and the second resources can be allocated through the corresponding CSI resource, CSI resource set, or resource setting configuration.

In some embodiments, assuming that an indicator indicating a specific beam at TRP 0, Cell 0, CC 0, or Panel 0 is denoted by PMI0, the relationship equation between the corresponding AoD and the AoS in the corresponding resources is denoted by PMI0=F (AoD or AoA), the BS may transmit this F(x) equation to the UE. At this time, F(x) may be configured in the corresponding reporting setting through higher layer signaling, and the BS may transmit the CSI request (e.g., downlink control information (CSI) includes a CSI request) to the UE. As an example, if the relationship equation of CSI-RS0 included in the corresponding report setting is denoted by PMI0=floor(AoD/10), AoD may be estimated to 21° by the UE.

Therefore, PMI0=floor(21/10)=2 can be denoted. The UE may transmit ‘PMI0=2’ to the BS through a PUCCH or PUSCH designated in the corresponding report setting, and the BS may also understand that AoD corresponding to PMI0 is in the range of 20° to 30°.

Proposal 4-1

The UE may transmit the corresponding PMI, CQI, L1-RSRP, or L1-SINR appropriate for (CSI) feedback to the BS according to (CSI) feedback payload within the CSI feedback transmission region (PUCCH and PUSCH) affected by either the received report setting or the received CSI request. Here, the transmission (Tx) information transferred to the BS may include long-term beam information (e.g., W1). The BS may acquire channel information (e.g., AoD, AoA, etc.) that was reversely calculated as a combination of the received PMI, CQI, L1-RSRP, or L1-SINR through the relationship equation (e.g., PMI=F(AoD, AoA)) between the beam indication (e.g., one resource, resource set, or the like) and the channel information. In addition, the BS may equally apply the long-term beam information (e.g., W1) received as the corresponding CSI feedback to similar resources in which reversely calculated channel information pieces from among the corresponding resources are similar to each other.

Therefore, if there is a resource set or resources having common channel information from among CSI feedback information that is transmitted through either the subsequent report setting or the subsequent CSI request, feedback for the long term beam information may be omitted as necessary.

The scope of the system to which the above-mentioned proposals are applied can be extended to 3GPP LTE system and other systems (e.g., UTRA, etc.), especially to 5G, beyond 5G, and candidate technology therefor.

As described above, since the CoMP operation based on the THz communication system is designed to use a higher frequency band than a target frequency band (under 100 GHz) of the legacy system (e.g., LTE, 5G), a channel environment different from those of the legacy communication system may occur. The present disclosure has disclosed not only the method for reducing CSI feedback required for the CoMP operation according to unique THz channel (e.g., 0.1-1 THz) characteristics, but also the method for additionally reducing the CSI feedback.

The above-described embodiments are combinations of elements and features of the present disclosure in prescribed forms. The elements or features may be considered as selective unless specified otherwise. Each element or feature may be implemented without being combined with other elements or features. Further, the embodiment of the present disclosure may be constructed by combining some of the elements and/or features. The order of the operations described in the embodiments of the present disclosure may be modified. Some configurations or features of any one embodiment may be included in another embodiment or replaced with corresponding configurations or features of the other embodiment. It is obvious to those skilled in the art that claims that are not explicitly cited in each other in the appended claims may be presented in combination as an embodiment of the present disclosure or included as a new claim by a subsequent amendment after the application is filed.

Those skilled in the art will appreciate that the present disclosure may be carried out in other specific ways than those set forth herein without departing from the essential characteristics of the present disclosure. The above embodiments are therefore to be construed in all aspects as illustrative and not restrictive. The scope of the disclosure should be determined by the appended claims and their legal equivalents, not by the above description, and all changes coming within the meaning and equivalency range of the appended claims are intended to be embraced therein.

### INDUSTRIAL APPLICABILITY

The method for receiving the channel state information (CSI) for the CoMP operation based on the terahertz (THz) communication system according to the present disclosure can be industrially applied to a variety of wireless communication systems, for example, 3GPP LTE/LTE-A system, NR(5G) communication system, and the like.

1. A method for enabling a base station (BS) to receive channel state information (CSI) for a CoMP (Coordinated Multi-Point transmission/reception) operation based on a terahertz (THz) communication system comprising:
transmitting, to a user equipment (UE), CSI association information for each TRP (Transmission and Reception Point), each panel, each BWP (bandwidth part), or each cell based on beam information of each TRP, each panel, each BWP, or each cell;
transmitting a first channel state information (CSI) request to the user equipment (UE);
receiving first channel state information (CSI) from the user equipment (UE) through a corresponding CSI feedback region based on a first report setting connected to the first CSI request; and
acquiring information of a TRP, a panel, a BWP, or a cell corresponding to the first CSI from among the TRP, the panel, the BWP, or the cell based on the first report setting.

2. The method according to claim 1, further comprising:
acquiring a precoding matrix indicator (PMI) subset of the TRP, the panel, the BWP, or the cell corresponding to the first CSI based on the CSI association information.

3. The method according to claim 2, further comprising:
transmitting a second CSI request including the PMI subset to the user equipment (UE).

4. The method according to claim 3, further comprising:
receiving a second CSI from the user equipment (UE) based on the second CSI request.

5. The method according to claim 1, wherein:
the beam information includes a precoding matrix indicator (PMI) acting as beam directivity information.

6. The method according to claim 1, wherein:
the CSI association information refers to information related to a single resource of each TRP, each panel, each BWP, or each cell.

7. The method according to claim 4, wherein:
the second CSI includes not only a best precoding matrix indicator (PMI), but also a channel quality indicator (CQI), L1-RSRP (Layer 1 reference signal received power), or L1-SINR (Layer 1-Signal to interference plus noise ratio) corresponding to the best PMI.

8. A method for enabling a user equipment (UE) to transmit channel state information (CSI) for a CoMP (Coordinated Multi-Point transmission/reception) operation based on a terahertz (THz) communication system comprising:
receiving CSI association information for each TRP (Transmission and Reception Point), each panel, each BWP (bandwidth part), or each cell based on beam information of each TRP, each panel, each BWP, or each cell, from a base station (BS);
receiving a first channel state information (CSI) request from the base station (BS); and
transmitting first channel state information (CSI) to the base station (BS) through a corresponding CSI feedback region based on a first report setting connected to the first CSI request.

9. The method according to claim 8, further comprising:
receiving a second CSI request based on the CSI association information from the base station (BS),
wherein the second CSI request includes a precoding matrix indicator (PMI) subset of a TRP, a panel, a BWP, or a cell corresponding to the first CSI.

10. The method according to claim 9, further comprising:
transmitting a second CSI to the base station (BS) based on the second CSI request,
wherein the second CSI includes not only a best PMI, but also a channel quality indicator (CQI), L1-RSRP (Layer 1 reference signal received power), or L1-SINR (Layer 1-Signal to interference plus noise ratio) corresponding to the best PMI.

11. A base station (BS) for receiving channel state information (CSI) for a CoMP (Coordinated Multi-Point transmission/reception) operation based on a terahertz (THz) communication system comprising:
a transmitter configured to transmit, to a user equipment (UE), CSI association information for each TRP (Transmission and Reception Point), each panel, each BWP (bandwidth part), or each cell based on beam information of each TRP, each panel, each BWP, or each cell, and to transmit a first CSI request to the user equipment (UE);
a receiver configured to receive first channel state information (CSI) from the user equipment (UE) through a corresponding CSI feedback region based on a first report setting connected to the first CSI request; and
a processor configured to acquire information of a TRP, a panel, a BWP, or a cell corresponding to the first CSI from among the TRP, the panel, the BWP, or the cell based on the first report setting.

12. A user equipment (UE) for transmitting channel state information (CSI) for a CoMP (Coordinated Multi-Point transmission/reception) operation based on a terahertz (THz) communication system comprising:
a receiver configured to receive CSI association information for each TRP (Transmission and Reception Point), each panel, each BWP (bandwidth part), or each cell based on beam information of each TRP, each panel, each BWP, or each cell, from a base station (BS), and to receive a first channel state information (CSI) request from the base station (BS); and
a transmitter configured to transmit first channel state information (CSI) to the base station (BS) through a corresponding CSI feedback region based on a first report setting connected to the first CSI request.
